(19) United States
(12) Patent Application Publication
(10) Pub. No.: US 2026/0313649 A1
(43) Pub. Date: Oct. 8, 2026

(54) UPLINK BEAM MANAGEMENT WITH LIMITED SIGNALING OVERHEAD

(71) Applicant: Telefonaktiebolaget LM Ericsson (publ), Stockholm (SE)

(72) Inventors: Joao VIEIRA, Hjärup (SE); Andreas NILSSON, Göteborg (SE)

(73) Assignee: Telefonaktiebolaget LM Ericsson (publ), Stockholm (SE)

(21) Appl. No.: 19/473,956

(22) PCT Filed: Apr. 11, 2023
(86) PCT No.: PCT/EP2023/059451

§ 371 Date: Oct. 9, 2025

(51) Int. Cl. H04W 72/21; H04B 7/06

(52) U.S. Cl. CPC H04W 72/21; H04B 7/06952

(57) ABSTRACT

A method (700) in a wireless device (120) for facilitating a determination of at least one transmit beam to be used in relation to a transmit-receive point (115a) or an access point in a wireless network (110), comprising: receiving (714) an uplink reference signal, UL RS, configuration grouped into a plurality of UL RS resource sets; receiving (716) an activation trigger, which indicates at least one of the configured UL RS resource sets; transmitting (718) on a plurality of UL RS resources in the indicated UL RS resource set(s); evaluating (718.1) a pre-agreed implicit dropping rule, which depends on a characteristic of the wireless device, for the indicated UL RS resource set(s) and deciding to omit transmission on at least one of the UL RS resources therein; and receiving (722) an instruction to use at least one transmit beam, each corresponding to one of the transmitted UL RS resources.

### TECHNICAL FIELD

The present disclosure relates to the field of cellular communication between multiantenna transceivers. In particular, it proposes a technique for determining a beam suitable for communication to a network node from a wireless device capable of simultaneous transmission at multiple antenna panels.

### BACKGROUND

In high frequency range (FR2), multiple RF beams may be used to transmit and receive signals at a base station (gNB) and a user equipment (UE). For each downlink transmit (DL Tx) beam from a gNB or a transmit receive point (TRP) associated with the gNB, there is typically an associated best receive (Rx) beam for receiving signals from the DL beam at the UE. The DL Tx beam and the associated UE Rx beam form a beam pair. The beam pair can be identified through a so-called beam management procedure in NR.

Although not explicitly stated in the NR specifications, it may be considered that beam management falls into three different procedures, which are schematically illustrated in FIG. 2:
P1: Purpose is to find an approximate direction for the UE 120 using wide gNB Tx beams 211, 212, 213 from the gNB 110 covering the whole angular sector. The UE 120 can use a single Rx beam 221.
P2: Purpose is to refine the gNB Tx beam by doing a new beam search around the coarse direction found in P1, namely, by transmitting regular (narrow) Tx beams 214, 215, 216. The UE 120 can use a single Rx beam 222.
P3: Used for UEs that have analog beamforming to let them find a suitable UE Rx beam. In P3, the UE 120 receives on multiple beams 223, 224, 225 while the gNB 110 transmits on a constant beam 217, which is preferably a regular (narrow) beam. In the P3 procedure, aperiodic CSI-RSs transmitted in one narrow gNB beam may be used.

UE may be equipped with multiple different UE panels, and the different UE panels may support different numbers of UE beams. A panel in this sense is a group of related transmit or receive antennas, as described in detail in the applicant's prior disclosure PCT/EP2022/076975. Moreover, each panel may support a dynamically varying number of UE beams, namely, if the beam width is configurable.

Current 3GPP NR specifications do not support UL beam management procedures in a suitable way for UEs with multiple UE panels, particularly when the different UE panels support different numbers of beams and/or number of ports. For example, from the NR specification, it can be understood that if the UE can only transmit from one panel at a time, then it can only be configured with on a Sounding Reference Signal (SRS) resource set with usage beamManagement. Hence, such an SRS resource set should then be used for all different UE panels, regardless of the structure of the UE panels, e.g., number of beams supported by that UE panels, number of TX/TRX chains supported by that UE panel, etc.

In addition, even if multiple SRS resource sets with usage beamManagement are configured for a UE that is able to transmit with multiple UE panels at a time, there is currently in NR no way for the network to know which UE panel(s) the UE will use for an UL beam management procedure; nor can the network rely on reported panel-related information with complete certainty about what panel it relates to. Hence, in a setup where there are different numbers of UE beams for different UE panels, the network cannot know how many beams the UE would like to sound, thus how many SRS resources the UE would like to transmit on.

In addition commercial NR time-division duplex (TDD) systems are known to suffer from a more or less constant deficiency in SRS capacity. When UL beam management procedures are to be used in mmWave TDD systems, the SRS capacity problem is expected to become even more severe. Hence, there is a need to reduce the SRS overhead in NR.

### SUMMARY

One objective of the present disclosure is to make available an uplink beam management procedure which utilizes available UL RS resources more efficiently. A further objective is to make available an uplink beam management procedure in which a limited amount of signaling suffices for configuring the UL RS resources to be used. A further objective is to make available an SRS-based uplink beam management procedure. A further objective is to make available an uplink beam management procedure that is suitable for UEs equipped with multiple antenna panels. In particular, the uplink beam management procedure should be resource-efficient, especially even in setups where the number of beams to be sounded differs between the panels of the UE.

At least some of these objectives are achieved by the invention as defined in the independent claims. The dependent claims are directed to advantageous embodiments.

The inventors propose, in a first aspect of the present disclosure, a method implemented in a wireless device, which method is suitable for facilitating a determination of at least one transmit beam to be used in relation to a transmit receive point (TRP) or an access point (AP) in a wireless network. The method comprises: receiving from the network an uplink reference signal (UL RS) configuration grouped into a plurality of UL RS resource sets; receiving from the network an activation trigger, which indicates at least one UL RS resource set from the configured UL RS resource sets; transmitting on a plurality of UL RS resources in the indicated UL RS resource set or sets; and receiving from the network an instruction to communicate with the network using at least one transmit beam, each transmit beam corresponding to one of the transmitted UL RS resources. According to the first aspect of the disclosure, the method further comprises evaluating a pre-agreed implicit dropping rule for the indicated UL RS resource set(s) and deciding to omit transmission on at least one of the UL RS resources therein.

Thanks to the implicit dropping rule, pre-agreed between the wireless device and the wireless network, the network can content itself with defining the UL RS configuration in broad terms with a certainty that the implicit dropping rule will make sure that redundant UL RS resources are dropped. For example, the network can configure all UL RS resource sets with an equal number of UL RS resources although it has knowledge about the UE (e.g., a capability indicated by the UE) from which it is clear that the full number will be used only in one of the UL RS resource sets. If all UL RS resource sets have an equal number of UL RS resources, it is only the first UL RS resource set that has to be defined by explicit signaling, whereas the second, third and further UL RS resource sets can refer to the first one; the reference may be an explicit signaling element or may follow implicitly by a syntax rule.

In addition to the lower signaling overhead, the method according to the first aspect also serves to liberate UL RS resources. In such circumstances where the network is in a position to predict-based on the implicit dropping rule or an explicit indication from the wireless device-which UL RS resources the wireless device is going to drop, these UL RS resources can be allocated to other devices served by the network.

The method according to the first aspect may as well be a tool to reduce interference. In particular, the omission of unneeded transmissions on UL RS resources may marginally reduce the inter-cell interference.

In a second aspect of the present disclosure, there is provided a method implemented in a network node of a wireless network, which method is suitable for facilitating a determination of at least one transmit beam to be used by a wireless device in relation to a transmit receive point (TRP) or an access point (AP) in the wireless network. The method comprises: transmitting to the wireless device an uplink reference signal (UL RS) configuration grouped into a plurality of UL RS resource sets; transmitting to the wireless device an activation trigger, which indicates at least one UL RS resource set from the configured UL RS resource sets; performing measurements on a plurality of UL RS resources in the indicated UL RS resource set or UL RS resource sets; selecting one or more of the UL RS resources on which measurements have been performed; and transmitting to the wireless device an instruction to communicate with the network using at least one transmit beam, each transmit beam corresponding to one of the transmitted UL RS resources. According to the second aspect, a measurement on at least one of the UL RS resources in the indicated UL RS resource set or UL RS resource sets is omitted in accordance with a pre-agreed implicit dropping rule, which depends on a characteristic of the wireless device.

Analogous to the method of the first aspect, the above-outlined network-side method reduces or limits the signaling overhead incurred by the UL RS configuration and it liberates UL RS resources on system level. Specifically, the network is hereby enabled to predict which UL RS resources the wireless device is going to drop and allocate them to other devices.

There is further provided, according to a third and fourth aspect of the present disclosure, a wireless device and a network node that operates in accordance with the above-described methods. In general terms, the wireless device and the network node share the effects and advantages of these methods, and they can be implemented with a corresponding degree of technical variation.

This disclosure will further describe a computer program containing instructions for causing a computer, or the wireless device or network node in particular, to carry out the above methods. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

The implicit dropping rule referred to above may depend on a characteristic of the wireless device. In different embodiments, this characteristic can be the number of beams supported by a panel of the wireless device, the number of beams of a given type supported by a panel, the number of ports supported by a panel, or other properties which are known directly or indirectly by the network as well as the wireless device.

In some embodiments, there is provided a special uplink beam management capability, a data structure by which a wireless device can indicate that it will apply the implicit dropping rule to any UL RS configuration it will receive from the network. This informs the network that it may content itself with a broad definition of the UL RS configuration, and leave the fine-tuning (trimming) the action of the dropping rule. The special uplink beam management capability may further include information relating to the panels of the wireless device.

In some embodiments, the wireless device indicates to the network an association between a TRP/AP and a panel of the wireless device, wherein each panel represents a group of antennas. This could guide the network's allocation of UL RS resources and could further help it predict more accurately what UL RS resources the implicit dropping rule will affect.

In some embodiments, the activation trigger includes an indication of a beam type to be used for transmitting the UL RS resources. Because the number of beams (per panel) supported by the wireless device may be different for different beam types, the indication of the beam type to be used helps the network node allocate the UL RS resources with greater accuracy, especially concerning their total number.

For the purposes of the present disclosure, a “beam” may be defined by an UL RS resource. More precisely, the UE may be required to sound a set of UL RS resources, wherein each UL RS resource is transmitted on a separate beam. The network may then schedule the UE on one of said beams by referring to one of the sounded UL RS resources, e.g., in terms of UL RS indices, which are in a one-to-one relationship with the corresponding beams.

In the present disclosure, further, the terms user equipment (UE) and wireless device are used interchangeably.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order described, unless explicitly stated.

### BRIEF DESCRIPTION OF THE DRAWINGS

Aspects and embodiments are now described, by way of example, with reference to the accompanying drawings, on which:

FIG. 1 shows a wireless device in the coverage area of one single-TRP base station and one multi-TRP base station;

FIG. 2 illustrates three example beam management procedures;

FIG. 3 illustrates uplink beam management;

FIG. 4 is a perspective view of a UE with four panels;

FIG. 5 is a schematic drawing of a UE with three panels oriented in orthogonal directions to improve coverage, wherein the UE has one baseband chain at its disposal that can be connected to one of the panels at a time;

FIG. 6 depicts an example use case of the present disclosure, namely, a communication setup including a UE with four panels which operates in a multi-TRP/D-MIMO mmWave deployment;

FIG. 7 is a sequence diagram illustrating a method of determining a beam to be used for communication between a network node and a UE; and

FIGS. 8 to 10 show example switching networks for a UE with four panels, where up to two panels can be used for simultaneous transmission.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

### System Overview

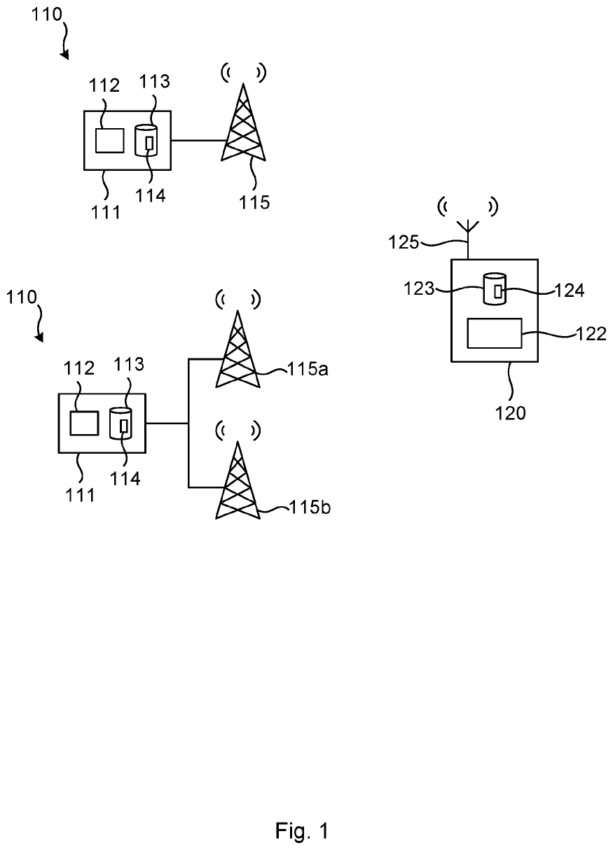

FIG. 1 relates to a first deployment where a wireless device 120 is located in the coverage area of one base station 110 with a single TRP 115 (upper portion of FIG. 1), and one base station 110 with two TRPs 115a, 115b (lower portion of FIG. 1). The base stations 110 are configured as network nodes in a radio access network within a cellular telecommunication system, such as a 3GPP NR system.

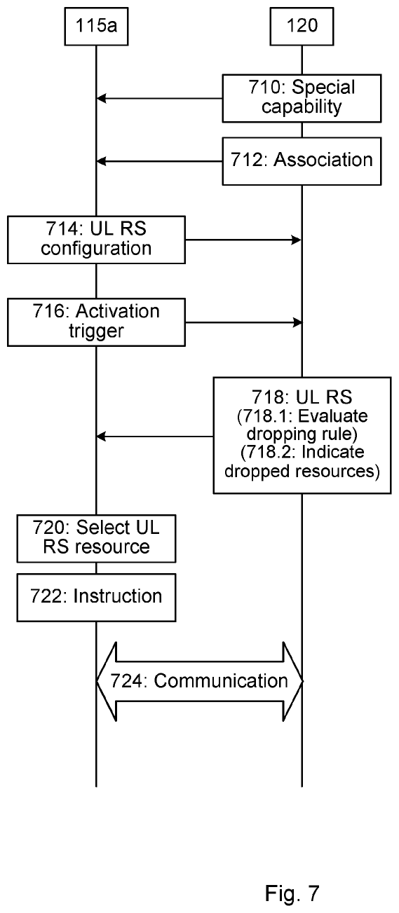

The figure schematically illustrates, in terms of a number of functional units, the components of the wireless device 120 according to an embodiment. Processing circuitry 122 is provided using any combination of one or more of a suitable central processing unit (CPU), multiprocessor, microcontroller, digital signal processor (DSP), etc., capable of executing software instructions stored in a computer program product 124, e.g. in the form of a storage medium 123. The processing circuitry 122 may further be provided as at least one application specific integrated circuit (ASIC), or field programmable gate array (FPGA). Particularly, the processing circuitry 122 is configured to cause the wireless device 120 to perform a set of operations, or steps, as disclosed below with reference to FIG. 7. For example, the storage medium 123 may store the set of operations, and the processing circuitry 122 may be configured to retrieve the set of operations from the storage medium 123 to cause the wireless device 120 to perform the set of operations. The set of operations may be provided as a set of executable instructions. Thus the processing circuitry 122 is arranged to execute the method for facilitating the determination of a beam to be used when the wireless device 120 communicates with the network node 110, to be described with reference to FIG. 7. The storage medium 123 may also comprise persistent storage, which, for example, can be any single one or combination of magnetic memory, optical memory, solid state memory or even remotely mounted memory.

The wireless device 120 may further comprise a communications interface 125 for communications with the network nodes 110. As such, the communications interface 125 may comprise one or more transmitters and receivers, comprising analog and digital components. The processing circuitry 122 controls the general operation of the wireless device 120, e.g. by sending data and control signals to the communications interface 125 and the storage medium 123, by receiving data and reports from the communications interface 125, and by retrieving data and instructions from the storage medium 123. Other components, as well as the related functionality, of the wireless device 120 are omitted in order not to obscure the concepts presented herein.

FIG. 1 further illustrates, in terms of a number of functional units, the components of the network nodes 110 according to an embodiment. Each network node 110 comprises a frontend unit 111 and at least one TRP 115. The frontend unit 111 may be co-located with the TRP 115 or located remotely from this. In the frontend unit 111, processing circuitry 112 is provided using any combination of one or more of a suitable CPU, multiprocessor, microcontroller, DSP, etc., capable of executing software instructions stored in a computer program product 114, e.g. in the form of a storage medium 113. The processing circuitry 112 may further be provided as at least one ASIC or FPGA. Particularly, the processing circuitry 112 is configured to cause each network node 110 to perform a set of operations, or steps, as disclosed below with reference to FIG. 7. For example, the storage medium 113 may store the set of operations, and the processing circuitry 112 may be configured to retrieve the set of operations from the storage medium 113 to cause the wireless device 110 to perform the set of operations. The set of operations may be provided as a set of executable instructions. Thus the processing circuitry 112 is arranged to execute the method for determining a beam to be used when the network node 110 communicates with the wireless device 120, to be described with reference to FIG. 7. The storage medium 113 may also comprise persistent storage, as exemplified above.

The network node 110 may further comprise a communications interface, including the TRP 115, for communications with the wireless device 120. As such, the communications interface may comprise one or more transmitters and receivers, comprising analogue and digital components. The processing circuitry 112 controls the general operation of the network node 110, e.g. by sending data and control signals to the communications interface (with the TRP 115) and the storage medium 113, by receiving data and reports from the communications interface, and by retrieving data and instructions from the storage medium 113. Other components, as well as the related functionality, of the network nodes 110 are omitted in order not to obscure the concepts presented herein.

### SRS

Before describing the inventors' contributions, some background concepts will be reviewed. In 3GPP NR, sounding reference signal (SRS) is used for providing a channel state indication (CSI) to the gNB in the UL. The usage of SRS includes, e.g., deriving the appropriate transmission/reception beams and/or performing link adaptation (i.e., setting the transmission rank and the MCS). SRS may further be used for selecting DL (e.g., for PDSCH transmissions) and UL (e.g., for PUSCH transmissions) MIMO precoding.

In LTE and NR, the SRS is configured via the Radio Resource Control (RRC) protocol, where parts of the configuration can be updated (for reduced latency) through MAC-CE signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the gNB in the DL, via the DCI in the PDCCH which instructs the UE to transmit the SRS once, at a predetermined time.

When configuring SRS transmissions, the gNB configures, through the SRS-ConfigIE, a set of SRS resources and a set of SRS resource sets, where each SRS resource set contains one or more SRS resources.

The resource usage, which is configured by the RRC parameter usage sets constraints and assumptions on the resource properties (see 3GPP TS 38.214 for further details). SRS resource sets can be configured with one of four different usages (‘antennaSwitching’, ‘codebook’, ‘nonCodebook’ and ‘beamManagement’), which is assigned to the parameter ‘usage’.
1. An SRS resource set that is configured with usage ‘antennaSwitching’ is used for reciprocity-based DL precoding (i.e., used to sound the channel in the UL so that the gNB can use reciprocity to set a suitable DL precoders). The UE is expected to transmit one SRS port per UE antenna port.
2. An SRS resource set that is configured with usage ‘codebook’ is used for codebook-based UL transmission (i.e., used to sound the different UE antennas and help the gNB to determine/signal a suitable UL precoder, transmission rank, and MCS for PUSCH transmission). There are up to two SRS resources in an SRS resource set with usage ‘codebook’. How SRS ports are mapped to UE antenna ports is, however, up to UE implementation and not known to the gNB.
3. An SRS resource set that is configured with usage ‘nonCodebook’ is used for NCB-based UL transmission. Specifically, the UE transmits one SRS resource per candidate beam (suitable candidate beams are determined by the UE based on CSI-RS measurements in the DL and, hence, reciprocity needs to hold). The gNB can then, by indicating a subset of these SRS resources, determine which UL beam(s) the UE should apply for PUSCH transmission. One UL layer will be transmitted per indicated SRS resource. Note that how the UE maps SRS ports to antenna ports is up to UE implementation and not known to the gNB.

4. An SRS resource set that is configured with usage ‘beamManagement’ is used (mainly for frequency bands above 6 GHZ, i.e., for FR2) to evaluate different UE beams for analog beamforming arrays. The UE transmits one SRS resource per analog beam, and the gNB will perform an RSRP measurement per transmitted SRS resource and, in this way, determine a suitable UE beam that is reported to the UE.

### SRS Antenna Switching

It is desirable for the gNB to sound all UE antennas, wherein sounding an antenna means transmitting an SRS from that antenna, which, in turn, enables the gNB to estimate the channel between said UE antenna and the antennas at the gNB. Since however it is generally costly to equip the UE with many transmit ports, SRS antenna switching was introduced in 3GPP NR Release 15, for several different UE architectures for which the number of receive chains is larger than the number of transmit chains. If a UE supports antenna switching, it will report so by means of UE-capability signaling.

As specified in 3GPP TS 38.306, a Release-15 UE can report the following antenna-switching capabilities using the IE supportedSRS-TxPortSwitch:
t1r2,
t1r4,
t2r4
t2r2,
t4r4,
   t1r4-t2r4.

For example, if a UE reports t1r2 in the UE-capability signaling, it means that it has two receive antennas (i.e., two receive chains) but is only capable of transmitting from one of those antennas at a time (i.e., one transmission chain) with support for antenna switching. In this case, two single-port SRS resources can be configured to the UE such that it can sound both receive ports using a single transmit port with an antenna switch in between.

Additional UE capabilities were introduced in NR Rel-16, where the IE supportedSRS-TxPortSwitch-r1610 can have values:
t1r1-t1r2,
t1r1-t1r2-t1r4,
t1r1-t1r2-t2r2-t2r4,
t1r1-t2r2,
t1r1-t2r2-t4r4,
t1r1-t1r2-t2r2-t1r4-t2r4.
   This IE can be used to indicate support for the UE to be configured with SRS resource set(s) with usage ‘antennaSwitching’ but where only a subset of all UE antennas is sounded. For example, the UE capability t1r1-t1r2 means that the gNB can configure one single-port SRS resource (same as no antenna-switching capability) or two single-port SRS resources (same as for the capability “t1r2” described above) with usage ‘antennaSwitching’ per SRS resource set. In this case, if the UE is configured with a single SRS resource (no antenna switching), it will only sound only one of its two antennas, which will save UE power consumption at the cost of reduced channel knowledge at the gNB (since the gNB can only estimate the channel between itself and the UE based on one of the two UE antennas).

For SRS resources with usage ‘antennaSwitching’ for a UE with fewer transmit chains than receive chains, a guard period has to be configured between SRS resources to account for Tx switching transient time. For subcarrier spacing below 120 kHz the guard period is 1 OFDM symbol, while for sub-carrier spacing of 120 kHz it is 2 OFDM symbols. This means that a UE is expected to be able to switch antenna within one or two OFDM symbols, depending on sub-carrier spacing.

### Multi-Beam Operation

### Beam Management Procedure

In high frequency range (FR2), multiple RF beams may be used to transmit and receive signals at a gNB and a UE. For each DL Tx beam from a gNB, there is typically an associated best UE Rx beam for receiving signals from the DL beam. The DL beam and the associated UE Rx beam form a beam pair. The beam pair can be identified through a so-called beam management procedure in NR.

A DL beam is (typically) identified by an associated DL reference signal (RS) transmitted in the beam, either periodically, semi-persistently, or aperiodically. The DL RS for the purpose can be a Synchronization Signal (SS) and Physical Broadcast Channel (PBCH) block (SSB) or a Channel State Information RS (CSI-RS), or the successors of any of these signals in future 6G specifications. By measuring all the DL RSs, the UE can determine and report to the gNB the best DL beam to use for DL transmissions. The gNB can then transmit a burst of DL-RS in the reported best DL beam to let the UE evaluate candidate UE Rx beams.

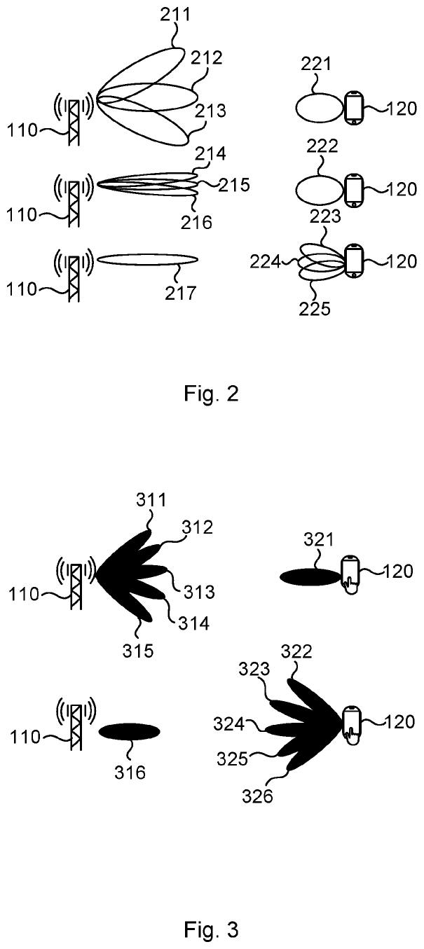

Although not explicitly stated in the NR specification, beam management has been divided into three procedures, schematically illustrated in FIG. 2:
P-1: Purpose is to find an approximate direction for the UE 120 using wide gNB Tx beams 211, 212, 213 from the gNB 110 covering the whole angular sector. The UE 120 can use a single Rx beam 221.
P-2: Purpose is to refine the gNB Tx beam by doing a new beam search around the coarse direction found in P-1, namely, by transmitting regular (narrow) Tx beams 214, 215, 216. The UE 120 can use a single Rx beam 222.
P-3: Used for UEs that have analog beamforming to let them find a suitable UE Rx beam. In P-3, the UE 120 receives on multiple beams 223, 224, 225 while the gNB 110 transmits on a constant beam 217, which is preferably a regular (narrow) beam.

P-1 is expected to utilize beams with rather large beamwidths and where the beam reference signals are transmitted periodically and are shared between all UEs of the cell. Typically reference signal to use for P-1 are periodic CSI-RS or SSB. The UE then reports the N best beams to the gNB and their corresponding RSRP values.

P-2 is expected to use aperiodic/or semi-persistent CSI-RS transmitted in narrow beams 214, 215, 216 around the coarse direction found in P-1.

P-3 is expected to use aperiodic or semi-persistent CSI-RSs repeatedly transmitted in one narrow gNB beam 217. One alternative way is to let the UE determine a suitable UE Rx beam based on the periodic SSB transmission. Since each SSB consists of four OFDM symbols, a maximum of four UE Rx beams 223, 224, 225 can be evaluated during each SSB burst transmission. One benefit with using SSB instead of CSI-RS is that no extra overhead of CSI-RS transmission is needed.

### Beam Indication

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving a signal on the other antenna port. For example, there may be a QCL relation between a tracking RS (TRS) and the PDSCH DMRS. When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in 3GPP NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its Rx beam in some direction prior to receiving a certain signal. If the UE knows that the signal is spatially QCL with some other signal it has received earlier, then it can safely use the same Rx beam to receive also this signal.

In NR, the spatial QCL relation for a DL or UL signal/channel can be indicated to the UE by using a “beam indication”. The “beam indication” is used to help the UE to find a suitable Rx beam for DL reception, and/or a suitable Tx beam for UL transmission. In NR, the “beam indication” for DL is conveyed to the UE by indicating a transmission configuration indicator (TCI) state to the UE, while in UL the “beam indication” can be conveyed by indicating a DL-RS or UL-RS as spatial relation (in NR Release 15/16) or a TCI state (in NR Release 17).

### UL Beam Management

Some UEs might have analog beamformers without beam correspondence or with poor beam correspondence (i.e. Tx/Rx correspondence), which implies that DL/UL reciprocity cannot always be used to determine the beams for these beamformers. For such UEs, the UE beam used for UL cannot be derived from beam management procedures based on DL reference signals as described above. To handle such UEs, UL beam management has been included in the NR standard specification since release 15. The main difference between normal beam management and UL beam management is that UL beam management utilizes uplink reference signals instead of DL reference signals. The UL reference signals that have been agreed to be used for UL beam management is sounding reference signals (SRS) in 3GPP NR; other reference signals may be used for this purpose according to future 6G specifications.

FIG. 3 schematically illustrates the two UL beam management procedures are supported in NR: U2 and U3. The U2 procedure (upper half) is performed by the UE 120 transmitting a burst of SRS resources in one UE Tx beam 321 and letting the gNB's TRP 110 evaluate different TRP Rx beams 311, 312, 313, 314, 315. The U3 procedure (lower half) lets the UE find a suitable UE Tx beam by transmitting different SRS resources in different UE Tx beams 322, 323, 324, 325, 326 while the TRP 110 maintains a constant beam 316.

UL beam management can also be useful even if UEs have beam correspondence. More precisely:
It can be argued that a combined DL beam management procedure and UL beam management procedure requires less overhead and latency compared to only using DL beam management procedures.
So-called ‘Uplink-only’ node deployments are a hot topic in 3GPP discussions, it being alleged that such deployments could improve UL coverage in a cost-efficient way (especially at higher frequencies). An “UL only” network node is equipped with UL capability but with none or very limited downlink capability. In this case, since the “UL only” node is not capable of transmitting DL reference signals, the beam pair link between a UE and an “UL only” node has to be based on UL beam management procedures.
In D-MIMO, there will be many different access points (AP) or transmission points (TRPs) in a small area, and where each AP/TRP might be equipped with multiple different beams. In case DL-beam management is used to determine a suitable AP/TRP and corresponding AP/TRP beam to a UE, significant amount of reference signal overhead is needed, which has been identified as an issue for D-MIMO. Hence, it has internally been suggested AP/TRP selection and corresponding beam selection should preferably be based on UL SRS transmission from the UE (which then could be used to determine suitable AP/TRP and corresponding AP/TRP beams for that UE).

Hence, it is likely that UL beam management will play a more significant role for 5G Advanced and 6G applications.

### UE Analog Beamforming Architecture

For UEs, the signals can arrive and emanate from all different directions, which makes it is beneficial to have an antenna implementation at the UE which has the possibility to generate omni-directional-like coverage in addition to the high gain narrow beams. One way to increase the omni-directional coverage at a UE is to install multiple panels, and point (orient) these panels into different directions, which typically is the case for commercial UEs. However, in order to reduce the cost and energy consumption, some of these UEs can only transmit from one UE panel at each point in time.

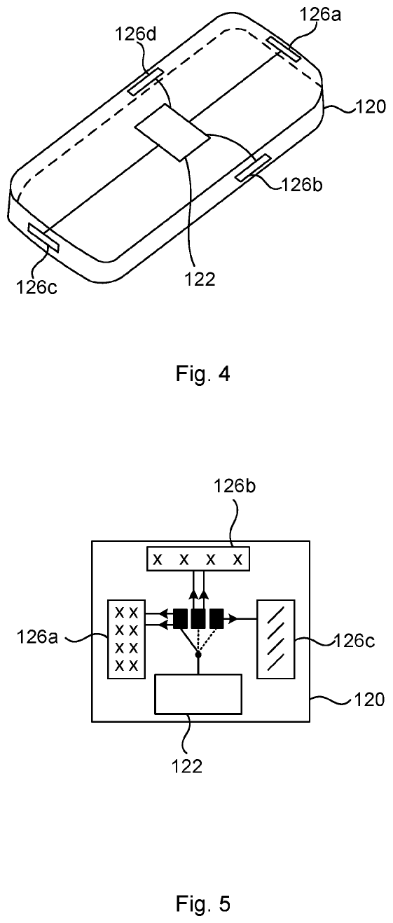

FIG. 4 illustrates one example of a realistic UE 120 with two baseband chains (one per polarization) 122 which are used to switch between four different dual-polarized panels 126. Each panel 126 is operable to transmit beams in directions typically corresponding to a half plane into the main transmit direction of the panel. More precisely, the antennas in one panel 126 may be oriented parallel to each other into a common direction.

Oftentimes though not necessarily, the antennas in one panel 126 are physically close, e.g., the mutual distances of the antennas in one panel 126 are smaller than the distance to an antenna in any other panel. Further, the antennas in one panel 126 may be fed with an RF signal at a common input point, which can be connected and disconnected to the baseband chain 122 collectively.

FIG. 5 shows a wireless device 120 with three panels 126 oriented in orthogonal directions to improve spherical coverage. The wireless device has two baseband chains 122 at its disposal that can be connected to one of the panels 126 at a time. This ability is illustrated by an analog switch in FIG. 5. Further, the panels 126 differ from each other with respect to maximum number of TX/RX chains, and number of antenna elements. In the drawing, the slash-like symbol inside a panel 126 refers to an antenna element with a first polarization, and the backslash-like symbol refers to an antenna element with a second polarization different from the first polarization.

With reference to a similar UE structure, it is described in the presentation
Qualcomm Technologies, Breaking the Wireless Barriers to Mobilize 5G NR mmWave, May 2019, downloaded from https://www.qualcomm.com/content/dam/qcomm-martech/dm-assets/documents/breaking_the_wireless_barriers_to_mobilize_5g_nr_mmwave.pdf
   how antenna switching can be used to switch between three UE panel modules M1, M2, M3.

A UE panel of a commercial UE can generate beams of different beam widths, as exemplified by Table 1.

TABLE 1

| | | Equivalent | | |
|---|---|---|---|---|
| | Half-power | isotropically | Number of | |
| Beamforming | beam width | radiated | pointing | |
| gain | (HPBW) | power (EIRP) | directions | |
| 0 dB | 90 degrees | 13 dBm | 1 | beam |
| 3 dB | 90 degrees | 19 dBm | 5 | beams |
| 9 dB | 30 degrees | 25 dBm | 9 | beams |

A widely practiced solution in commercial UEs is to generate the wider beams by temporarily deactivating one or more power amplifiers (PAs) of the panel. This evidently has a negative impact on the available output power. However, it is possible to mitigate the output-power loss when generating wide beams by applying dual-polarized beamforming, e.g., using array-size-invariant (ASI) beamforming. It is useful for the UE to generate a wide beam of a panel during beam sweep procedures to first find a coarse direction to a serving AP/TRP, which would enable the UE to select and activate a suitable UE panel. In the example of Table 1, the UE can generate one wide beam, five semi-wide (or half-wide) beams, and nine narrow beams for each panel.

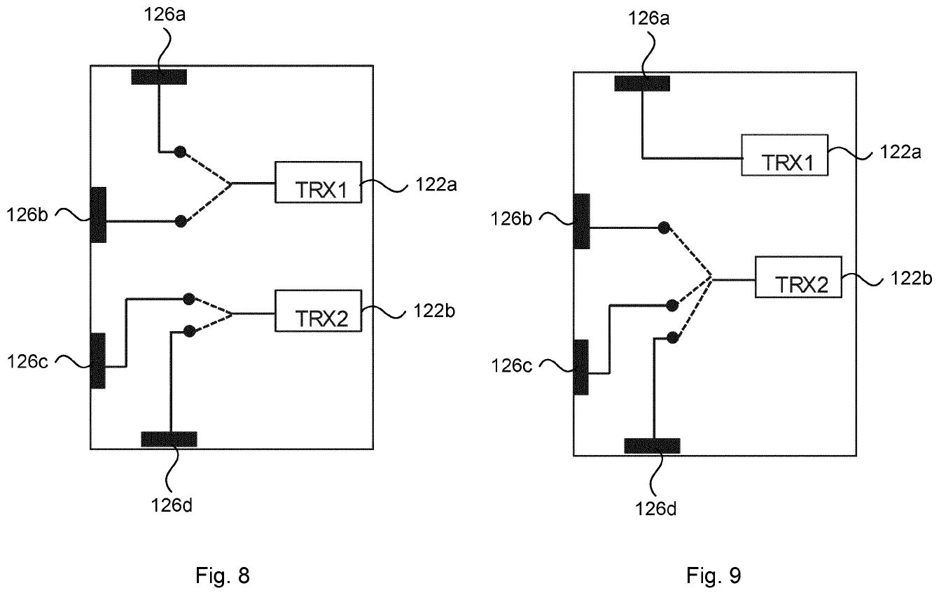

Because different UEs may have panel-switching networks with different layouts, the UEs differ with respect to the UE panels/beams that can be used for simultaneous transmission or simultaneous reception. FIGS. 8, 9 and 10 schematically depict three examples that illustrate this variation between UEs.

In FIG. 8, the two upper UE panels 126a, 126b cannot be used for simultaneous DL/UL transmission/reception because they share the upper transceiver chain 122a. Similarly, the two lower UE panels 126c, 126d cannot be used for simultaneous DL/UL transmission/reception because they share the lower transceiver chain 122b. An exhaustive list of all pairs of simultaneously transmitting/receiving panels is thus: {126a, 126c}, {126b, 126c}, {126a, 126d} and {126b, 126d}. All other UE panel combinations are excluded. The panel-switching network in FIG. 8 may be characterized as a balanced panel-switching network.

In FIG. 9, the upper UE panel 126a has the upper transceiver chain 122a to itself. The three lower UE panels 126b, 126c, 126d however cannot be used for simultaneous DL/UL transmission/reception because they share the lower transceiver chain 122b. Considering the unequal association of panels to transceiver chains, the panel-switching network in FIG. 9 may be characterized as an unbalanced panel-switching network.

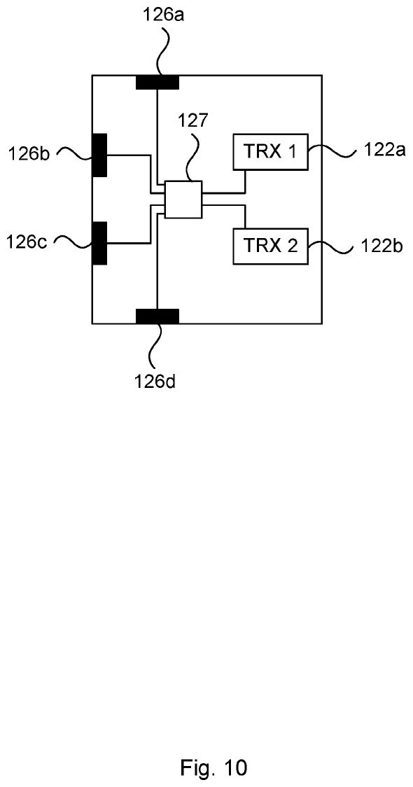

In FIG. 10, finally, there is illustrated a panel-switching network with a central universal switch 127, which is operable to connect any one UE panel 126 to any one transceiver chain 122. The panel-switching network in FIG. 10 may thus be characterized as a fully flexible panel-switching network.

Simultaneous Transmission from Multiple UE Panels

In current NR, a UE can signal support for UL beam management procedures by indicating the capability uplinkBeam Management during UE capability signaling. This capability is defined as follows in 3GPP TS 38.331:
“Defines support of beam management for UL. This capability signalling comprises the following parameters:
maxNumberSRS-ResourcePerSet-BM indicates the maximum number of SRS resources per SRS resource set configurable for beam management, supported by the UE.”
   As part of this capability, the UE can indicate maximum number of supported SRS resources per SRS resource set with usage beam management with the parameter maxNumberSRS-ResourcePerSet-BM, which could be used as an indication of the number of narrow beams the UE have for the UE panel. However, note that only a single value can be reported, hence there is no possibility to indicate different number of supported beams for different UE panels or different number of beams for different beam widths.

In 3GPP NR up to Release 17, the discussions regarding UL transmission for FR2 have mainly focused on UEs capable of single-panel transmissions, that is, transmissions from a single UE panel at each time instance rather than multiple panels. In Release 18, however, it has been agreed to specify support for two different Simultaneous Multi-Panel Transmission (STxMP) schemes. These are: Spatial domain multiplexing (SDM), where different layers are transmitted from two different UE panels, and Single Frequency Network (SFN) transmission scheme, where the same layers are transmitted from two different UE panels.

### Uplink Beam Management Method

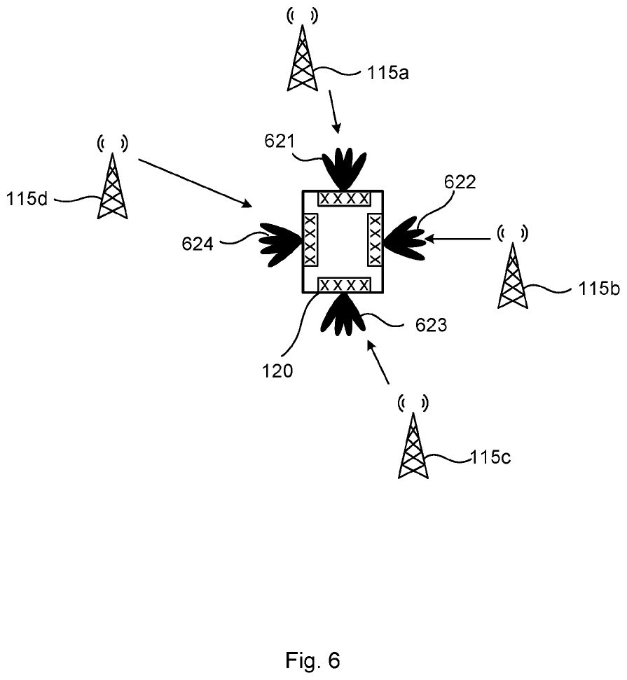

FIG. 6 depicts an example use case of the present disclosure, in which a UE 120 with four panels operates in a multi-TRP/D-MIMO mmWave deployment. More precisely, a UE 120 with four panels is located in an intersection of coverage areas of the TRPs 115a, 115b, 115c, 115d. The wireless device 120 is configured for operation in the mmWave (or sub-terahertz) band, or more generally in any frequency band where analog beamforming is used. Each panel is operable to transmit beams 621, 622, 623, 624 in directions typically corresponding to a half plane into the main transmit direction of each panel. Specifically, different UE panels are associated with different TRPs/APs 115 in the sense that a specific UE panel is best situated for receiving from that TRP/AP and/or the UE 120 has indicated such an association (without specifying reasons) to the network.

The present disclosure addresses, among others, the stage when the network has already as determined suitable TRP/APs and/or at least one suitable beam per TRP/AP for the UE, for example by relying on some degree of channel reciprocity when processing transmitted UL signals/channels, or based on a TRP/AP beam report (e.g. associated a previously performed P1 or P2 procedure). After this, the next step is to determine suitable UE beams for respective identified serving TRP/AP. Please note that even if the UE can only simultaneously transmit on a subset of its available panels—the cardinality of this subset may be smaller than the number of TRPs—the UE could still be helped by determining beam pair links with respect to all candidate TRPs/APs. This is because the reliability of the communication between network and UE is more improved the more TRPs are used. Indeed, current NR specifications include time division multiplexing (TDM) repetitions schemes over two different TRP for all DL and UL channels, which have shown to improve reliability compared to single TRP repetition due to improved spatial diversity.

Reference is made to FIG. 7, which is a sequence diagram illustrating a method of determining one or more transmit beams to be used for communication between a wireless device 120 (or UE) and at least one network node 110 (e.g., a TRP or an AP or a node controlling one of these) in a wireless network. From the wireless device's 120 point of view, FIG. 7 provides a method for facilitating the determination of one or more transmit beams to be used by the wireless device 120 for communication with the network node 110. From the network node's 110 perspective, FIG. 7 provides a method for determining one or more transmit beams to be used by the wireless device 120 for communication with the wireless device 120; additionally, the network node 110 may determine one or more beams for its own use in said communication. Preferably, the wireless device 120 is a wireless device with analog beamforming.

In a first step 710 of the method 700, the wireless device 120 indicates to the network node 110 a “Special uplink beam management capability” referring to an implicit dropping rule, i.e., that the wireless device supports and applies the implicit dropping rule. Step 710 may not be needed in the method 700 if it is implemented in such a technical context where the applicable specifications imply that all served wireless devices 120 must support the implicit dropping rule.

In some embodiments, the “Special uplink beam management capability” (which may carry a different name) includes one or more of the following:
1. an indication that the wireless device supports implicit dropping of UL RS resources in a triggered UL RS resource set, which has been configured for UL beam management;
2. an indication that the wireless device supports implicit dropping of UL RS ports for UL RS resources in a triggered UL RS resource set, which has been configured for UL beam management;
3. a number of panels 126 of the wireless device, each panel 126 representing a group of related antennas;
4. a number of supported beam types per panel 126, each beam type associated with a different beam width;
5. an approximate beam width of a supported beam type;
6. a number of supported beams for a supported beam type;
7 a number of supported beams for a panel 126;
8. a number of supported beams for a supported beam type and a panel 126;
9. a number of supported narrow beams for a panel 126;
10. a number of supported ports for a panel 126;
11. a number of, or identifiers of, those panels 126 that are capable of simultaneous transmission;
12. a number of available transmit chains for a panel 126.

With reference to items 8-9, the number of supported beams of a given type refers to a number of unique transmit beams of that type that the wireless device 120 wishes to evaluate. The wireless device 120 may indicate, in the special beam sweep capability, as many beams of that type that it is capable of, or fewer beams. Formulated differently, the number of supported beams in the special beam sweep capability need not be a technically exhaustive description of the wireless device's 120 hardware or software, but rather refers to the number of beams the wireless device 120 wants to have evaluated with the assistance of the network. The number of supported beams indicated in the special uplink beam management capability may be understood as a preferred number of beams.

For example, the information in accordance with item 11 may be used by the network node 110 in order to provide an UL RS configuration which includes as many UL RS resource sets configured for UL beam management as there are panels capable of simultaneous transmission.

In an optional second step 712, which may form part of the method 700 together with step 710 or on its own, the wireless device 120 indicates to the network node 110, for at least one of the wireless device's 120 panels 126, an association between that panel and a TRP/AP 115. The association can be used as the wireless device 120 sees fit, e.g., to indicate that a certain panel 126 currently has an advantageous orientation relative to the TRP/AP 115. Further, according to some embodiments, it may be understood that if the wireless device 120 indicates two such associations, between a first panel 126 and a first TRP/AP 115 and between a second panel 126 and a second TRP/AP 115, then the wireless device 120 shall support simultaneous beam sweeps on the first and second panels 126, i.e., the UL RS resources for these first and second panels 126 can be partially overlapping in time.

It is understood that step 712 is typically performed in advance. For example, the indication 712 of the association between the panel 126 and the TRP/AP 115 is made in a different beam management procedure than the transmission (see step 718 below) to be made on said UL RS resources. A further option is to that the indication 712 and the measurements 718 belong to two instantiations of the same type of beam management procedure.

The method 700 includes a step 714, where the network node 110 transmits—and the wireless device 120 receives—a UL RS configuration, which contains UL RS resources that are grouped into a plurality of UL RS resource sets. Functionally, the UL RS configuration indicates a number of UL RS resources which form several groups (UL RS resource sets). The fact that a group of UL RS resources belong to a particular UL RS resource set may be recognizable in that they carry an equally valued UL RS resource set index and/or they occupy certain positions in a data structure that represents the UL RS configuration. The UL RS resource sets may all have an equal number of UL RS resources, or this number may differ across the UL RS resource sets. The UL RS resource sets may all have an equal number of UL RS ports, or the number of ports may differ across the UL RS resource sets.

The UL RS configuration may be transmitted to the wireless device 120 from a TRP 115a. The UL RS configuration may be conveyed using semistatic signaling, such as RRC signaling.

The UL RS resources may correspond to Sounding Reference Signal (SRS) resources. The UL RS resource sets may consist of UL RS resources for aperiodic transmission with respect to the time domain; possible alternatives include semi-persistent or periodic transmission.

In 3GPP NR implementations, it is optional to indicate a usage beamManagement representing evaluation of different UE beams for analog beamforming arrays. An equivalent usage can be indicated in 6G implementations of the method 700.

The method 700 further includes a step 716, in which the wireless device 120 receives an activation trigger from the network node 110. The activation trigger indicates at least one UL RS resource set from the configured UL RS resource sets. (The activation trigger may be said to be associated with this UL RS resource set or sets.) The activation trigger can be conveyed in Downlink Control Information (DCI), in a MAC-layer control element (MAC-CE) or by RRC signaling. In 6G implementations, another suitable signaling vehicle may be relied on.

In some embodiments, the activation trigger includes an indication of a beam type to be used by the wireless device for transmitting on the UL RS resources in the indicated UL RS resource set. The indicated beam type may have been selected from a plurality of predefined beam types which have, among themselves, two or more unique beam widths. Additionally or alternatively, the activation trigger may include an indication of a number of UL RS resources to transmit on in the indicated UL RS resource set.

In further embodiments, the activation trigger includes a number of UL RS resources to transmit on in the indicated UL RS resource set.

In still further embodiments, the activation trigger includes identifiers of one or more UL RS resources to transmit on in the indicated UL RS resource set. Equivalently, and possibly more economically from a signaling point of view, the activation trigger may include identifiers of one or more UL RS resources to be dropped. Either way, the implicit dropping rule stipulates simply that the content of the activation trigger is to be observed.

After the wireless device 120 has received the activation trigger, it transmits, in step 718, on a plurality of UL RS resources in the indicated UL RS resource set or sets. (Using language closer to some passages of 3GPP TS 38.214, the wireless device 120 may be said to transmit said plurality of UL RS resources.) Meanwhile, the network node 110 performs measurements on the transmitted UL RS resources. The measurements may be SRS measurements in accordance with a 3GPP NR specification or in accordance with a 6G specification.

Step 718 includes a substep 718.1 of evaluating a pre-agreed implicit dropping rule, which depends on a characteristic of the wireless device, for the indicated UL RS resource set(s) and deciding to omit transmission on at least one of the UL RS resources therein. Omitting a transmission on a DL RS resource may correspond to transmitting with at most 10% of a nominal transmit energy, preferably transmitting with zero energy (with transmit circuitry active), and more preferably forgoing transmission (with transmit circuitry not active). Correspondingly, the measurement by the network node 110 on that UL RS resource(s) is omitted. From the network node's 110 perspective, the omission may occur knowingly or unawares. More precisely, the network node 110 may refrain from any measurement effort (e.g., activating receive circuitry) if it becomes aware in advance that the wireless device 120 is not going to transmit on the UL RS resource(s). Alternatively, the network node 110 may carry out a measurement on an UL RS resource on which the wireless device 120 omits transmission, in which case the measurement is likely to predominantly capture noise and interference, or to have low signal energy.

In a next step 720, on the basis of the measurements in step 718, the network node 110 may select a most suitable transmit beam or transmit beams to be used by the wireless device 120. The network node 110 may select one or more transmit beams from a first panel 126 and one or more transmit beams from a second panel 126. The transmit beam may be identified in terms of an UL RS resource, normally the UL RS resource on which the UL RS was received by the network node 110 with highest signal energy or highest signal to interference and noise ratio (SINR).

The selected beam or beams are then used by the network node 110 and wireless device 120 for communication, in a step 722, by uplink transmissions of data and signaling. Step 722 may optionally include simultaneous downlink reception and/or simultaneous uplink transmission from multiple UE panels 126.

Some specific embodiments and further development of the above-described basic method 700 will now be discussed.

In one embodiment, all UL RS resource sets configured for UL beam management in the UL RS resource configuration have an equal number of UL RS resources, the special uplink beam management capability (indicated in step 710) includes a number of supported beams for at least two panels 126, and the UL RS resource sets configured for UL beam management in the UL RS resource configuration include as many UL RS resources as the maximum number of supported beams for a panel. By the action of the implicit dropping rule, the UL RS resource corresponding to that or those panels which do not support the full number of beams will be dropped. In particular, the maximum number of supported beams for a panel may be the maximum over all beam types, i.e., normally the number of beams with the smallest width.

In one embodiment, at least two UL RS resource sets in the UL RS resource configuration have different numbers of UL RS resources, and the indicated special uplink beam management capability includes identifiers of panels that are capable of simultaneous transmission and the number of supported beams for each of these panels. Then, the network node 110 may define an UL RS resource configuration with n UL RS resource sets for use by an n-tuple of simultaneously transmitting panels, and the first through nth UL RS resource set have a respective number of UL RS resources corresponding to a maximum number of supported beams of a subgroup of the panels. This embodiment may include an optimization-like process where the panels 126 of the wireless device 120 are purposefully grouped into ‘small’, ‘medium’, ‘large’ and ‘very large’ ones with respect to their supported number of beams. This approach may also be applied to each supported beam type. As a result, the same UL RS resource sets (four in this example) can be reused. The optimization-like process may further try to minimize the number of dropped resources. As a result, while the implicit dropping rule will be active, the number of dropped UL RS resources is kept low or even minimal.

Continuing the example of Table 1, the following input data

| | | |
|---|---|---|
| Panel 1, beam width A | 1 | beam |
| Panel 1, beam width B | 5 | beams |
| Panel 1, beam width C | 9 | beams |
| Panel 2, beam width A | 1 | beam |
| Panel 2, beam width B | 4 | beams |
| Panel 2, beam width C | 12 | beam |
| Panel 3, beam width A | 1 | beam |
| Panel 3, beam width B | 4 | beams |
| Panel 3, beam width C | 10 | beams |

may under this embodiment lead to the following UL RS configuration

| | | |
|---|---|---|
| UL RS resource set S1 | 1 | beam |
| UL RS resource set S2 | 5 | beams |
| UL RS resource set S3 | 12 | beams |

where one may identify n=3. If UL RS resource set S1, S2 and S3 are used for beam widths A, B and C, respectively, for all panels, then no UL RS resources will be dropped in UL RS resource set S1, at most one (=5-4) UL RS resource will be dropped in UL RS resource set S2, and at most three (=12-9) UL RS resources will be dropped in UL RS resource set S3.

Another embodiment targets the situation where the special uplink beam management capability includes a number of supported ports for at least two panels. Then, all UL RS resource sets configured for UL beam management in the UL RS resource configuration can be given an equal number of UL RS ports, and the UL RS resource sets configured for UL beam management in the UL RS resource configuration have as many UL RS ports as the maximum number of supported ports. When the special uplink beam management capability includes a number of available transmit chains for at least two panels, then all UL RS resource sets configured for UL beam management in the UL RS resource configuration can be given an equal number of UL RS ports, and the UL RS resource sets configured for UL beam management in the UL RS resource configuration can have as many UL RS ports as the maximum number of available transmit chains for said at least two panels. In each case, the implicit dropping rule will make sure that those UL RS resources which are in excess of the maximum number of supported ports and maximum number of transmit chains, respectively, will be dropped.

The implicit dropping rule may be defined differently in different embodiments of the method 700. For example, the implicit dropping rule may stipulate that any UL RS resources in an UL RS resource set shall be dropped which are in excess of the number of beams which a panel associated (as indicated in step 712) with the UL RS resource set supports (as indicated in step 710). Specifically, the implicit dropping rule may stipulate that all such excess UL RS resources shall be dropped.

When this teaching is applied to the case where the UL RS resource set includes N_{R} UL RS resources and the special uplink beam management capability indicates that the panel associated with the UL RS resource set supports N_{B} beams of a beam type to be used, then the implicit dropping rule stipulates that the number of UL RS resources in the UL RS resource set that shall be dropped is equal to the difference N_{R}-N_{B}. The beam type to be used may have a specific width, such as narrow, semi-wide or wide, and the beam type may be communicated in the activation trigger (step 716).

In another embodiment, targeting such cases where an association between a TRP/AP and a panel of the wireless device has been indicated, the implicit dropping rule stipulates that any UL RS ports in an UL RS resource set shall be dropped which are in excess of the number of ports supported by a panel associated with the UL RS resource set. Alternatively or additionally, the implicit dropping rule may stipulate that any UL RS ports in an UL RS resource set shall be dropped which are in excess of the number of transmit chains available for said panel. In some implementations, the transmit chains correspond to ports, so that the number of supported ports is equal to the number of available transmit chains.

In one example of applying the teachings of this embodiment, the UL RS resource set includes UL RS resources with N_{R} ports, the special uplink beam management capability indicates that a panel associated with the UL RS resource set supports Np ports (and/or that Np transmit chains are available for the panel), and the implicit dropping rule stipulates that UL RS resources with N_{R}-N_{P} ports in the UL resource set shall be dropped. Formulated differently, knowing that an UL RS resource may specify a port and two or more UL RS resources may specify the same port, this example provides that the UL RS resource set before dropping includes UL RS resources that specify a total of N_{R} unique ports, and the UL RS resources to be dropped specify—together—a total of unique N_{R}-N_{P} ports. Under one option, the implicit dropping rule stipulates that the N_{R}-N_{P} UL RS resources which shall be dropped are those with the lowest port indices. Under another option, the implicit dropping rule stipulates that the N_{R}-N_{P} UL RS resources which shall be dropped are those with the highest port indices.

In some embodiments, the implicit dropping rule may stipulate that any UL RS resources in the indicated UL RS resource set shall be dropped which are in excess of the number of beams of the indicated beam type supported by a panel which the wireless device 120 uses for transmitting on the UL RS resource set. It may be known to the network node 110 what beam type the wireless device will use. In one example, the activation trigger transmitted in step 716 may include an indication of a beam type to be used by the wireless device for transmitting on the UL RS resources in the indicated UL RS resource set(s). In another example, the beam type can be deducible from the current operating state or similar circumstances, or there may be only a single beam type for the wireless device 120 to choose from. Further, it may be known to the network node 110 what panel the wireless device 120 is going to use for what UL RS resource set, and this knowledge enables the network node 110 to predict the UL RS resource to be dropped, i.e., the UL RS resource for which the wireless device 120 is going to omit transmission.

In such embodiments of the method 700 where the activation trigger includes an indication of a number of UL RS resources to transmit on in the indicated UL RS resource set, the implicit dropping rule may stipulate that any UL RS resources in the indicated UL RS resource set shall be dropped which are in excess of the indicated number of UL RS resources. In particular, the implicit dropping rule may stipulate that if the indicated UL RS resource set includes N_{R} UL RS resources and the activation trigger includes an indication of NA UL RS resources to transmit on in the indicated UL RS resource set, then N_{R}-NA UL RS resources in the UL RS resource set are to be dropped. The number NA may be equal to the number of beams supported by the associated panel 126.

In these embodiments, furthermore, the implicit dropping rule may further stipulate which ones of the UL RS resources in the UL RS resource set are going to be dropped. Some envisioned options are:
the UL RS resources which shall be dropped are first in time in the indicated UL RS resource set;
the UL RS resources which shall be dropped are last in time in the indicated UL RS resource set;
the UL RS resources which shall be dropped have the lowest UL RS resource indices in the indicated UL RS resource set;
the UL RS resources which shall be dropped have the highest UL RS resource indices in the indicated UL RS resource set.

In some embodiments of the method 700, step 718 comprises a further substep 718.2, in which the wireless device 120 transmits to the network node 110 an indication of at least one UL RS resource, on which the wireless device is going to omit transmission. Thanks to this early indication, the network is free to reallocate the indicated UL RS resources to a different wireless device (not shown) served by the network, which may contribute to efficient use of the UL RS resources on system level. Even if the indicated UL RS resources are not reallocated to a different wireless device, the network node 110 may itself benefit from the indication 718.2 by saving the measurement effort (e.g., activation of receive circuitry) on the UL RS resources in question.

Summing up the present disclosure in general terms, a number of standards enhancements for UL beam management have been described, which target UEs equipped with different types of UE panels. In a first instance, the UE signals to the gNB enhanced information associated with properties of its antenna panels, such as number of panels, beams per panel, or the like. The gNB then uses said information in order to configure the UE with suitable UL RS resources sets parameterizations. Next, the gNB triggers the UE to transmit the configured UL RS resources. The UE then transmits the triggered UL RS resources (from different panels/beams) and drops one or more of the triggered UL-RS resources. The dropping may occur for panels that support fewer beams than the number of configured UL-RS resources.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1-40. (canceled)

41. A method implemented in a wireless device for facilitating a determination of at least one transmit beam to be used in relation to a transmit receive point (TRP) or an access point (AP) in a wireless network, the method comprising:
receiving from the network an uplink reference signal (UL RS) configuration grouped into a plurality of UL RS resource sets;
receiving from the network an activation trigger, which indicates at least one UL RS resource set from the configured UL RS resource sets;
transmitting on a plurality of UL RS resources in the indicated UL RS resource set(s);
receiving from the network an instruction to communicate with the network using at least one transmit beam, each transmit beam corresponding to one of the transmitted UL RS resources; and
evaluating a pre-agreed implicit dropping rule, which depends on a characteristic of the wireless device, for the indicated UL RS resource set(s) and deciding to omit transmission on at least one of the UL RS resources therein.

42. The method of claim 41, wherein
the method further comprises indicating to the network a special uplink beam management capability referring to said implicit dropping rule.

43. The method of claim 42, wherein
the special uplink beam management capability comprises:
an indication that the wireless device supports implicit dropping of UL RS resources in a triggered UL RS resource set, which has been configured for UL beam management;
an indication that the wireless device supports implicit dropping of UL RS ports for UL RS resources in a triggered UL RS resource set, which has been configured for UL beam management;
a number of panels of the wireless device, each panel representing a group of related antennas;
a number of supported beam types per panel, each beam type associated with a different beam width;
an approximate beam width of a supported beam type;
a number of supported beams for a supported beam type;
a number of supported beams for a panel;
a number of supported beams for a supported beam type and a panel;
a number of supported narrow beams for a panel;
a number of supported ports for a panel;
a number of, or identifiers of, those panels that are capable of simultaneous transmission; and/or
a number of available transmit chains for a panel.

44. The method of claim 43, wherein
the special uplink beam management capability includes a number of, or identifiers of, those panels that are capable of simultaneous transmission, each panel representing a group of related antennas; and
the UL RS configuration includes as many UL RS resource sets configured for UL beam management as there are panels capable of simultaneous transmission.

45. The method of claim 42, wherein
all UL RS resource sets configured for UL beam management in the UL RS resource configuration have an equal number of UL RS resources,
the special uplink beam management capability includes a number of supported beams for at least two panels, each panel representing a group of related antennas; and
the UL RS resource sets configured for UL beam management in the UL RS resource configuration include as many UL RS resources as the maximum number of supported beams for a panel.

46. The method of claim 42, wherein
at least two UL RS resource sets in the UL RS resource configuration have different numbers of UL RS resources,
the special uplink beam management capability includes identifiers of panels that are capable of simultaneous transmission, each panel representing a group of related antennas, and a number of supported beams for each of these panels;
the UL RS resource configuration consists of n UL RS resource sets for use by an n-tuple of simultaneously transmitting panels; and
the first through nth UL RS resource set have a respective number of UL RS resources corresponding to a maximum number of supported beams of a subgroup of the panels.

47. The method of claim 42, wherein
all UL RS resource sets configured for UL beam management in the UL RS resource configuration have an equal number of UL RS ports
the special uplink beam management capability includes a number of supported ports for at least two panels and/or a number of available transmit chains for at least two panels, each panel representing a group of related antennas, and
the UL RS resource sets configured for UL beam management in the UL RS resource configuration have as many UL RS ports as the maximum number of supported ports and/or the maximum number of available transmit chains for said at least two panels.

48. The method of claim 41, wherein
omitting transmission on a UL RS resource corresponds to transmitting with at most 10% of a nominal transmit energy, preferably transmitting with zero energy, and more preferably forgoing transmission.

49. The method of claim 41, wherein
the method further comprises transmitting to the network an indication of at least one UL RS resource, on which the wireless device is going to omit transmission.

50. The method of claim 41, wherein
all UL RS resource sets configured for UL beam management in the UL RS resource configuration have an equal number of UL RS ports.

51. The method of claim 41, wherein
all UL RS resource sets configured for UL beam management in the UL RS resource configuration have an equal number of UL RS resources.

52. The method of claim 41, wherein
at least two UL RS resource sets in the UL RS resource configuration have different numbers of UL RS resources.

53. The method of claim 41, wherein
the method further comprises indicating to the network an association between a TRP/AP and a panel of the wireless device, each panel representing a group of antennas.

54. The method of claim 50, wherein
the implicit dropping rule stipulates that any UL RS resources in an UL RS resource set shall be dropped which are in excess of the number of beams supported by a panel associated with the UL RS resource set.

55. A method implemented in a network node of a wireless network for facilitating a determination of at least one transmit beam to be used by a wireless device in relation to a transmit receive point (TRP) or an access point (AP) in the wireless network, the method comprising:
transmitting to the wireless device an uplink reference signal (UL RS) configuration grouped into a plurality of UL RS resource sets;
transmitting to the wireless device an activation trigger, which indicates at least one UL RS resource set from the configured UL RS resource sets;
performing measurements on a plurality of UL RS resources in the indicated UL RS resource set(s);
selecting one or more of the UL RS resources on which measurements have been performed; and
transmitting to the wireless device an instruction to communicate with the network using at least one transmit beam, each transmit beam corresponding to one of the transmitted UL RS resources, wherein
a measurement on at least one of the UL RS resources in the indicated UL RS resource set(s) is omitted in accordance with a pre-agreed implicit dropping rule, which depends on a characteristic of the wireless device.

56. The method of claim 55, wherein
the method further comprises obtaining an indication of a special uplink beam management capability referring to said implicit dropping rule.

57. The method of claim 55, wherein
the method further comprises receiving from the wireless device an indication of at least one UL RS resource, on which the wireless device is going to omit transmission, and omitting the measurement on said at least one UL RS resource.

58. The method of claim 55, wherein
the method further comprises obtaining an indication of an association between a TRP/AP and a panel of the wireless device, each panel representing a group of antennas.

59. A wireless device for facilitating a determination of at least one transmit beam to be used in relation to a transmit receive point (TRP) or an access point (AP) in a wireless network, the wireless device comprising:
a transmitter;
a receiver; and
processing circuitry, wherein the wireless device is operable to perform a method comprising:
receiving from the network an uplink reference signal (UL RS) configuration grouped into a plurality of UL RS resource sets;
receiving from the network an activation trigger, which indicates at least one UL RS resource set from the configured UL RS resource sets;
transmitting on a plurality of UL RS resources in the indicated UL RS resource set(s);
receiving from the network an instruction to communicate with the network using at least one transmit beam, each transmit beam corresponding to one of the transmitted UL RS resources; and
evaluating a pre-agreed implicit dropping rule, which depends on a characteristic of the wireless device, for the indicated UL RS resource set(s) and deciding to omit transmission on at least one of the UL RS resources therein.

60. A network node of a wireless network for facilitating a determination of at least one transmit beam to be used by a wireless device in relation to a transmit receive point (TRP) or an access point (AP) in the wireless network, the network node comprising:
a transmitter;
a receiver; and
processing circuitry, wherein the network node is operable to perform a method comprising:
transmitting to the wireless device an uplink reference signal (UL RS) configuration grouped into a plurality of UL RS resource sets;
transmitting to the wireless device an activation trigger, which indicates at least one UL RS resource set from the configured UL RS resource sets;
performing measurements on a plurality of UL RS resources in the indicated UL RS resource set(s);
selecting one or more of the UL RS resources on which measurements have been performed; and
transmitting to the wireless device an instruction to communicate with the network using at least one transmit beam, each transmit beam corresponding to one of the transmitted UL RS resources,
wherein a measurement on at least one of the UL RS resources in the indicated UL RS resource set(s) is omitted in accordance with a pre-agreed implicit dropping rule, which depends on a characteristic of the wireless device.
